(19) United States
(12) Patent Application Publication
(10) Pub. No.: US 2007/0162186 A1
(43) Pub. Date: Jul. 12, 2007

(54) Memory flashing and data collection device for motor vehicles

(76) Inventors: Geoff L. Baugher, West Bloomfield, MI (US); Ronald F. Rastenis, Dearborn Heights, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/299,916

(22) Filed: Dec. 12, 2005

(51) Int. Cl. G05B 23/00

(52) U.S. Cl. 700/275

(57) ABSTRACT

A portable, hand-carriable access device for communicating with a vehicular electronic control unit is coupled to a vehicular communication bus of the vehicle. The device includes a microprocessor, a bus interface unit coupled to the microprocessor and adapted to be coupled to the vehicular communication bus, a memory card port coupled to the microprocessor and adapted to receive a memory card and operative to send script files resident on the memory card to the microprocessor, and a host communication port coupled to the microprocessor and operative to enable data communication between the microprocessor and a remote host computer. The microprocessor is operative to carry out various operations with the vehicular electronic control unit via the vehicular communication bus in accordance with instructions received via the memory card port and/or the host communication port.

### BACKGROUND OF THE INVENTION

The invention relates to an access device to a vehicular electronic control unit coupled to a vehicular communication bus. More specifically, the invention concerns an access device for either flashing memory in the vehicle's electronic unit or retrieving data therefrom.

Prior devices for flashing the memory of a vehicular electronic control module and/or for capturing data therefrom have been large, bulky and incorporated outdated and complicated user interface software, thereby preventing true portability and the capability of operating in a stand-alone mode, or being small enough to plug directly into a diagnostic connector of the vehicle bus.

### SUMMARY OF THE INVENTION

A portable, hand-carriable access device for communicating with a vehicular electronic control unit is coupled to a vehicular communication bus of the vehicle. The device includes a microprocessor, a bus interface unit coupled to the microprocessor and adapted to be coupled to the vehicular communication bus, a memory card port coupled to the microprocessor and adapted to receive a memory card and operative to send script files resident on the memory card to the microprocessor, and a host communication port coupled to the microprocessor and operative to enable data communication between the microprocessor and a remote host computer. The microprocessor is operative to carry out various operations with the vehicular electronic control unit via the vehicular communication bus in accordance with instructions received via the memory card port and/or the host communication port.

### BRIEF DESCRIPTION OF THE DRAWING

The objects and features of the invention will become apparent from a reading of a detailed description, taken in conjunction with the drawing, in which:

FIG. 1 is a functional block diagram of an access device arranged in accordance with the principles of the invention; and

FIG. 2 is a perspective view of an access device arranged in accordance with the principles of the invention.

### DETAILED DESCRIPTION

The following description is merely exemplary in nature and is not intended to limit the present disclosure, application or uses.

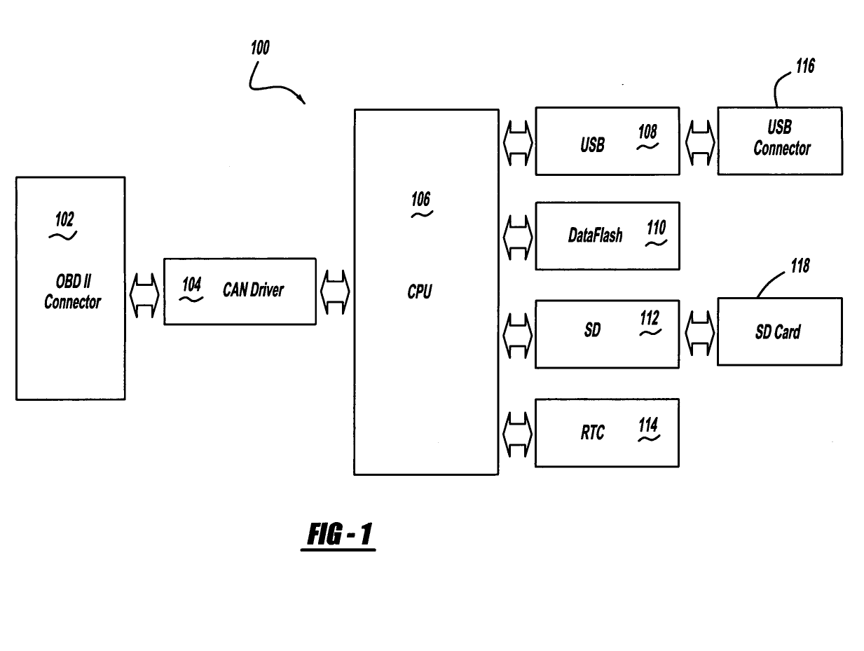

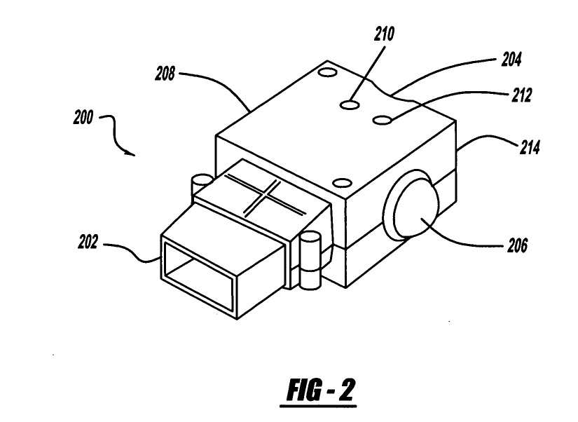

With reference to FIGS. 1 and 2, access device 100 of FIG. 1 or 200 of FIG. 2 is a multi-function electronic tool providing engineering access to at least one vehicular electronic control unit (ECU). The device programs ECU flash memory, provides some diagnostic access for recognizing and clearing faults and captures data. The device can be operated in a stand-alone mode through script files resident on a memory card coupled to the device or with a host computer via wired connections using, for example, USB commands or wirelessly using, for example, a Bluetooth® protocol.

As seen from the perspective view of FIG. 2, access device 200 has a connector 202 removably mating with a bus connector on the vehicle, such as an off-board diagnostics connection. A secure digital (SD) card slot 208 is adapted to receive a secure digital data card. A USB client port 204 is compatible with a USB bus for communication with a remote host computer. Alternatively, the device may include chip-implemented capability for wirelessly communicating with a remote host via a protocol such as the Bluetooth® protocol. A large status indicator lamp 206 is provided at one side of the device and two additional indicator lamps or LED's 210 and 212 are provided on a top surface of the access device 200.

As seen from the functional block diagram of FIG. 1, access device 100 features a CPU or microprocessor unit 106 coupled for bi-directional communication with USB instructions 108 which are in turn received via a USB connector 116 from a remote host computer (not shown). Additionally, microprocessor 106 is bi-directionally communication coupled with a data flash unit 110, a secure digital card port 112 which is adapted to receive a secure digital card 118 and a real time clock unit implemented on a separate chip 114.

One well-known vehicular bus communication device utilizes the CAN protocol. In the example arrangement of FIG. 1, microprocessor 106 communicates with at least one ECU in the vehicle via a CAN driver 104 and an off-board diagnostics connector 102 permanently associated with the vehicle's CAN bus.

The stand alone real time clock 114 is battery powered. RTC 114 may be adjusted from a remote host computer via, for example, a USB command.

Data capture is a feature of access device 100 where interrogated data may be stored in files on a SD card 112 or streamed via USB or Bluetooth® to a host computer. Two available modes of data capture—fill and circular—are provided. The fill mode works similarly to a tape recorder. In the fill mode, data capture begins when started by the operator. Data acquisition then continues until a preselected event time has elapsed.

The circular mode of data capture is designed to capture transient data. The resulting event file contains data recorded before and after a triggering event. While capturing data in the circular mode, a portion of memory is continuously overwritten until the trigger criterion is satisfied. Once triggered, data continues to be captured for the post-trigger time and then captured data is written out as an event file.

The status of data capturing is indicated by a flashing light 206 of FIG. 2. If LED or lamp 210 is simultaneously flashing with lamp 206, then a pre-trigger circular mode data acquisition is indicated. If smaller lamp or LED 212 is flashing, then post-trigger circular or fill mode data acquisition is indicated.

During data capture, the event files are transferred either to SD card 112 or via USB connector 116 or a wireless Bluetooth® transmission to a remote host.

The foregoing detailed description has been presented for the sake of example only. The scope and spirit of the invention are to be found in properly interpreted appended claims.

What is claimed is:

1. A portable, hand carriable access device for communicating with a vehicular electronic control unit coupled to a vehicular communication bus, the device comprising:
a microprocessor;
a bus interface unit coupled to the microprocessor and adapted to be coupled to the vehicular communication bus;
a memory card port coupled to the microprocessor, adapted to receive a memory card and operative to send script files resident on the memory card to the microprocessor; and
a host communication port coupled to the microprocessor and operative to enable data communication between the microprocessor and a remote host computer;
the microprocessor operative to carry out various operations with the vehicular electronic control unit via the vehicular communication bus in accordance with instructions received via the memory card port and/or the host communication port.

2. The access device of claim 1 wherein the various operations include flashing a memory unit of the vehicular electronic control unit.

3. The access device of claim 1 wherein the various operations include capturing data from a memory unit of the vehicular electronic control unit.

4. The access device of claim 3 wherein the microprocessor writes captured data to a memory card resident in the memory card port.

5. The access device of claim 3 wherein the microprocessor writes captured data to a remote computer communicating with the microprocessor via the host communication port.

6. The access device of claim 1 wherein the various operations include clearing a fault in the vehicular electronic control unit.

7. The access device of claim 1 wherein the bus interface unit further comprises:
a bus driver having first and second input/output ports; and
a connector coupled to the first input/output port and adapted to removably mate with a vehicular connector associated with the vehicular communication bus, the second input/output port coupled to the microprocessor.

8. The access device of claim 1 wherein the memory card port is adapted to removably receive a secure digital memory card.

9. The access device of claim 1 wherein the host communication port comprises a USB port.

10. The access device of claim 1 further comprising a real time clock coupled to the microprocessor.

11. The access device of claim 1 further comprising at least one indicator of an operating status of the access device.

12. The access device of claim 1 further comprising a plurality of visual indicator elements for indicating an operating status of the access device.

13. The access device of claim 12 wherein the microprocessor causes the plurality of visual indicator elements to present a plurality of patterns of visual indications, each pattern representing a different operating status of the access device.
